(19) United States
(12) Patent Application Publication
(10) Pub. No.: US 2020/0012990 A1
(43) Pub. Date: Jan. 9, 2020

(54) SYSTEMS AND METHODS OF NETWORK-BASED INTELLIGENT CYBER-SECURITY

(71) Applicant: Demisto Inc., Cupertino, CA (US)

(72) Inventors: Rishi Bhargava, Cupertino, CA (US); Meir Wahnon, Tel Aviv (IL)

(21) Appl. No.: 16/029,264

(22) Filed: Jul. 6, 2018

(51) Int. Cl. G06Q 10/06; H04L 29/06; H04L 12/24

(52) U.S. Cl. CPC G06Q 10/063112; G06Q 10/0633; H04L 41/06; H04L 41/16; H04L 63/20

(57) ABSTRACT

A comprehensive security operation platform with artificial intelligence capabilities which may collaborate and/or automate tasks, including complex and/or redundant security tasks. An automated system may assist security analysts and security operations center managers in discovering security incidents. A comprehensive security operations platform may combine intelligent automation scale and collaborative human social learning, wisdom and experience. An automated system may empower security analysts to resolve incidents faster and reduce redundancy through collaboration with peers in virtual war rooms. An automated system may automate security analyst work by executing tasks from the war room or by following playbooks defined by the security analysts.

### FIELD

The present disclosure relates generally to systems and methods of implementing cyber security and more particularly to methods and systems of automatically combatting cyber security threats within one or more computer networks.

### BACKGROUND

As computer networks become commonplace in businesses, the threat of cyber-security attacks affecting users and devices throughout a network becomes ever more present. The need for an active cyber security threat monitoring system is critical. To combat the threat of cyber security attacks, organizations implement a large number of security products and hire many security analysts. As the threats of cyber security attacks grow in number and the increasingly large number of security products are installed on various user devices throughout a network, the ability of a security analyst to identify attacks in time to mitigate damage is hindered.

The large number of security products, instead of helping security analysts in combating security threats, complicate the issue by inundating security analysts with security alerts. Security analysts may investigate a number of different alerts daily, document each of them, and report them regularly. As a result, security analysts may end up having “alert fatigue” or otherwise become less responsive to each individual security alert. Much of the work security analysts perform is essentially duplicating past work of another security analyst.

A primary objective of cyber security systems, including work by cyber security analysts, is to ultimately maximize system security and minimize network damage resulting from cyber security threats. An ongoing challenge in cyber security analysis is combatting numerous threats playing out simultaneously across a network. Cyber security analysts must find ways to optimize the response time and maximize efficiency. Current products for cyber security threat analysis are simply lacking in efficiency and require many educated analysts working around the clock to identify, analyze, and remediate many types of threats across a network.

There remains a need for a more efficient system enabling cyber security analysts to be more efficient and capable of responding to threats requiring human interaction while being free from the distractions of tasks which are capable of being performed solely by a computer system. It is therefore desirable to provide an automated system of cyber security threat analysis.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment in accordance with at least some embodiments of the present disclosure;

FIG. 2 illustrates a network environment in accordance with at least some embodiments of the present disclosure;

FIG. 3A is a block diagram of a packet in accordance with at least some embodiments of the present disclosure;

FIG. 3B illustrates a database in accordance with at least some embodiments of the present disclosure;

FIG. 3C illustrates a database in accordance with at least some embodiments of the present disclosure;

FIG. 3D illustrates a database in accordance with at least some embodiments of the present disclosure;

FIG. 3E illustrates a database in accordance with at least some embodiments of the present disclosure;

FIG. 4 illustrates a user interface in accordance with at least some embodiments of the present disclosure;

FIG. 5A illustrates a user interface in accordance with at least some embodiments of the present disclosure;

FIG. 5B illustrates a user interface in accordance with at least some embodiments of the present disclosure;

FIG. 5C illustrates a user interface in accordance with at least some embodiments of the present disclosure;

FIG. 5D illustrates a user interface in accordance with at least some embodiments of the present disclosure;

FIG. 5E illustrates a user interface in accordance with at least some embodiments of the present disclosure;

FIG. 5F illustrates a user interface in accordance with at least some embodiments of the present disclosure;

FIG. 6A illustrates a user interface in accordance with at least some embodiments of the present disclosure;

FIG. 6B illustrates a user interface in accordance with at least some embodiments of the present disclosure;

FIG. 6C illustrates a user interface in accordance with at least some embodiments of the present disclosure;

FIG. 6D illustrates a user interface in accordance with at least some embodiments of the present disclosure;

FIG. 7 is a flowchart of a method in accordance with at least some embodiments of the present disclosure;

FIG. 8 is a flowchart of a method in accordance with at least some embodiments of the present disclosure;

FIG. 9 is a flowchart of a method in accordance with at least some embodiments of the present disclosure;

FIG. 10A is a flowchart of a method in accordance with at least some embodiments of the present disclosure;

FIG. 10B is a flowchart of a method in accordance with at least some embodiments of the present disclosure; and

FIG. 11 is a flowchart of a method in accordance with at least some embodiments of the present disclosure.

### DETAILED DESCRIPTION

What is needed is a comprehensive security operation platform with artificial intelligence capabilities which may collaborate and/or automate tasks, including complex and/or redundant security tasks. An automated system may assist security analysts and security operations center managers in discovering security incidents. A comprehensive security operations platform may combine intelligent automation scale and collaborative human social learning, wisdom and experience. An automated system may empower security analysts to resolve incidents faster and reduce redundancy through collaboration with peers in virtual war rooms. An automated system may automate security analyst work by executing tasks from the war room or by following playbooks defined by the security analysts.

These and other needs are addressed by the various embodiments and configurations of the present invention. The invention is directed generally to automated and partially-automated methods of analyzing security threats as well as methods and systems for assisting human security analysts in the identification and targeting of security threats. By utilizing a system of automating, either fully or partially, steps required during a security threat analysis, security analysts may be free to pursue other tasks, for example tasks requiring human input. These and other advantages will be apparent from the disclosure of the invention(s) contained herein.

The phrases “plurality”, “at least one”, “one or more”, and “and/or” are open-ended expressions that are both conjunctive and disjunctive in operation. For example, each of the expressions “a plurality of A, B, and C”, “at least one of A, B, and C”, “at least one of A, B, or C”, “one or more of A, B, and C”, “one or more of A, B, or C”, and “A, B, and/or C” means A alone, B alone, C alone, A and B together, A and C together, B and C together, or A, B and C together.

The term “a” or “an” entity refers to one or more of that entity. As such, the terms “a” (or “an”), “one or more”, and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The term “data stream” refers to the flow of data from one or more, typically external, upstream sources to one or more downstream reports.

The term “dependency” or “dependent” refers to direct and indirect relationships between items. For example, item A depends on item B if one or more of the following is true: (i) A is defined in terms of B (B is a term in the expression for A); (ii) A is selected by B (B is a foreign key that chooses which A); and (iii) A is filtered by B (B is a term in a filter expression for A). The dependency is “indirect” if (i) is not true; i.e. indirect dependencies are based solely on selection (ii) and or filtering (iii).

The terms “determine”, “calculate” and “compute,” and variations thereof, as used herein, are used interchangeably and include any type of methodology, process, mathematical operation or technique.

The term “item” refers to data fields, such as those defined in reports, reporting model, views, or tables in the database.

The term “module” as used herein refers to any known or later developed hardware, software, firmware, artificial intelligence, fuzzy logic, or combination of hardware and software that is capable of performing the functionality associated with that element. Also, while the invention is described in terms of illustrative embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

Although the present disclosure is discussed with reference to security analysis systems, it is to be understood that the invention can be applied to numerous other architectures, such as any system utilizing a computer network and/or a network of less sophisticated computing devices like the Internet of Things (IoT). The present disclosure is intended to include these other architectures and network types.

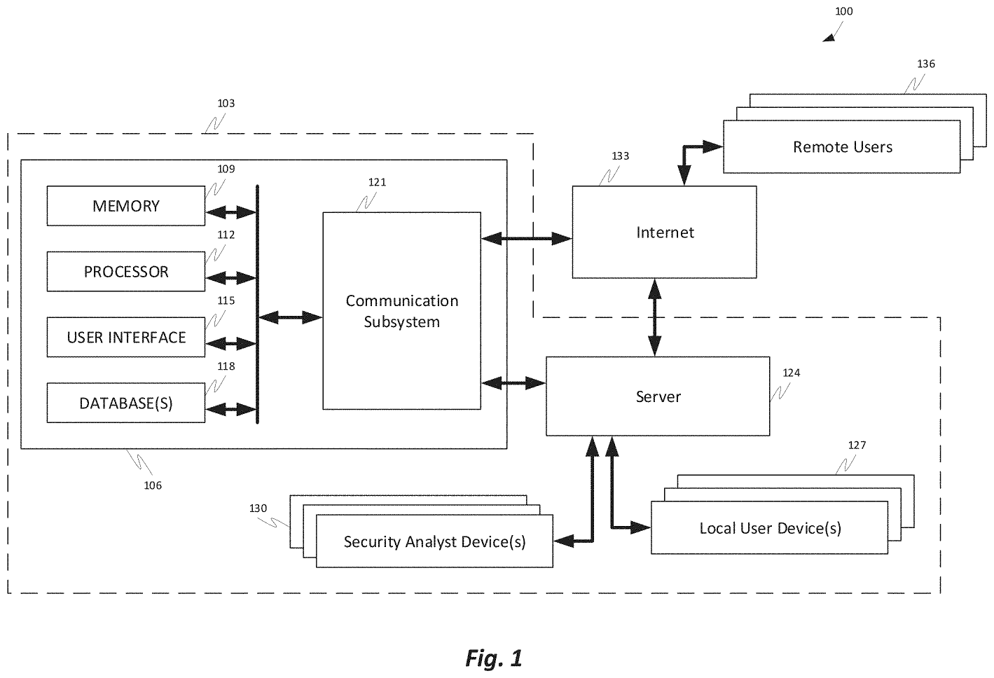

As illustrated in FIG. 1, a computer network environment 100 in accordance with some embodiments may comprise a local network 103 in communication with a wide area network (WAN) such as the Internet 133. In some embodiments, a local network 103 may comprise a security operation platform 106. A security operation platform 106 may be a computer system comprising one or more memory devices 109, one or more processors 112, one or more user interface devices 115, one or more databases 118, and a communication subsystem 121. The security operation platform 106 may, in some embodiments, be part of a local network 103 comprising a local server 124 and a number of local user devices 127. The local network 103 may further comprise one or more security analyst devices 130 in communication with the security operation platform 106 via the server 124. The communication subsystem 121 of the security operation platform 106 may be connected to and in communication with the local server 124 as well as a wide area network (WAN) such as the Internet 133. Via the Internet 133, the security operation platform 106 may be capable of communicating with a number of remote users 136, which may or may not correspond to trusted or known users. Although not depicted, the local network 103 may be separated from any untrusted network (in the form of the Internet 133) by a firewall, gateway, session border controller or similar type of network border element. In some embodiments, a firewall and/or gateway may be positioned between the server 124 and Internet 133. The same firewall and/or gateway or a different firewall and/or gateway may be positioned between the communication subsystem 121 and the Internet 133. The placement of the firewall and/or gateway enables the firewall and/or gateway to intercept incoming and outgoing traffic travelling between the Internet 133 and local network 103. As is known in the networking arts, the firewall and/or gateway may perform one or more inspection processes on the data packets/messages/data streams passing there through and, in some instances, may intercept and quarantine such data packets/messages/data streams if determined to be (or likely to be) malicious.

The security operation platform 106 may also be in communication with one or more security analyst devices 130. For example, a security analyst working at a security analyst terminal, computer, or other computing device 130, may be capable of working in tandem with the security operation platform 106. Data may be shared between the security operation platform 106 and the one or more security analyst devices 130.

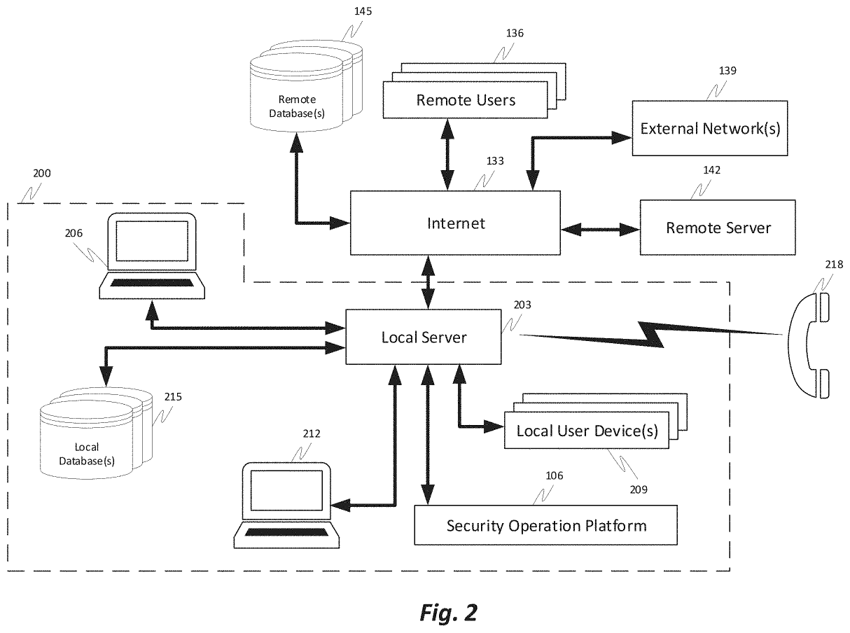

As illustrated in FIG. 2, the Internet 133 may provide access to one or more external networks 139, external servers 142, remote user devices 136, remote databases 145, and web services.

The local network 200, in some embodiments, may comprise one or more local servers 203, network administrator devices 206, local user devices 212, local databases 215, etc. As with FIG. 1, although not depicted, a firewall and/or gateway device may be positioned between the local server 203 and Internet 133, thereby providing security mechanisms for the network 200.

The security operation platform 106 may also be capable of placing telephone calls via a phone line 218 or via VoIP and/or sending automated email messages.

Telephone calls made by the security operation platform 106 may be automatically dialed by the system and conducted by a security analyst user of the security operation platform 106. In some embodiments, the security operation platform 106 may present a notification display to the security analyst user instructing the security analyst user with details on which number to dial and what questions to ask. In some embodiments, the security operation platform 106 may auto-dial the number and instruct the security analyst user to ask particular questions. In some embodiments, the security operation platform 106 may auto-dial the number and play recorded messages instructing a receiver of the phone call to input data via the telephone.

Similarly, emails may be automatically drafted and sent by the security operation platform 106 in some embodiments, while in other embodiments the security operation platform 106 may instruct a security analyst to draft and/or send the email.

The security operation platform 106 may be capable of automatically making a number of machine-to-machine inquiries. For example, if the security operation platform 106 determines certain data is required, the security operation platform 106 may determine a location, e.g. a network location, where such data may be found. The security operation platform 106 may then send a request or poll or otherwise gather such data.

In some embodiments, a workflow may begin upon a cyber security event being detected or upon a user request. For example, a user may submit information to a security operation platform providing details on a suspected cyber security threat. Alternatively, a security operation platform may detect a cyber security event occurring on a network.

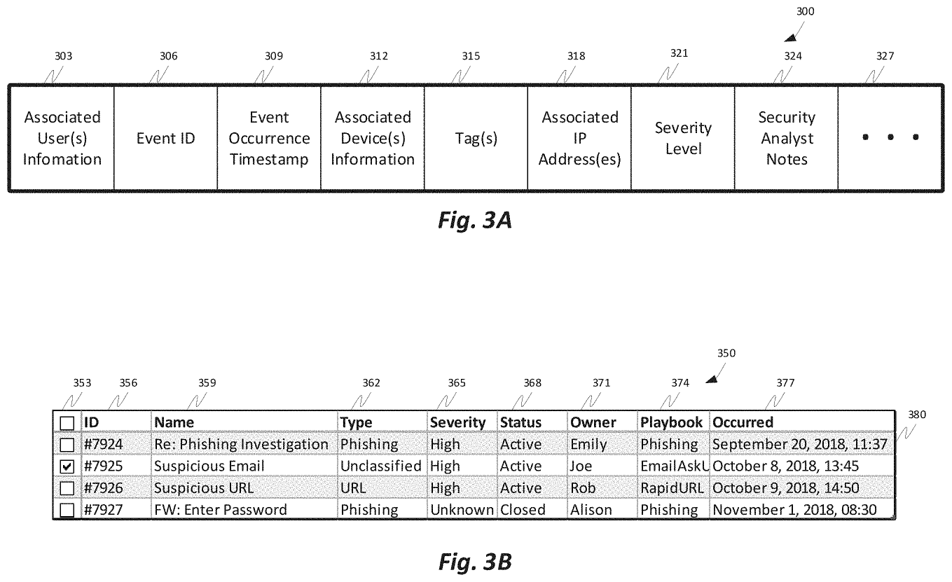

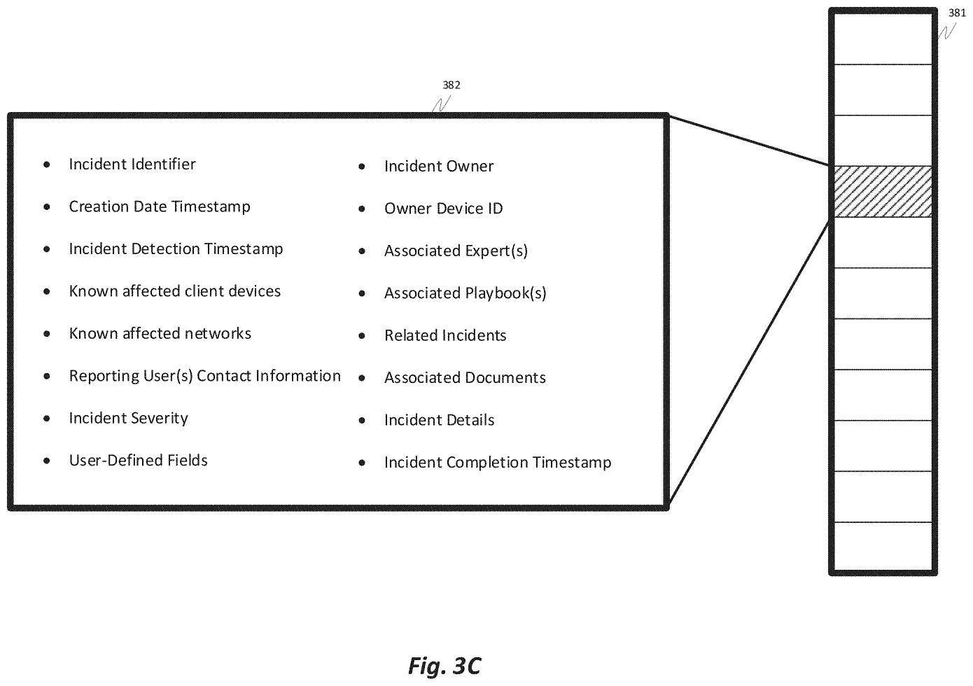

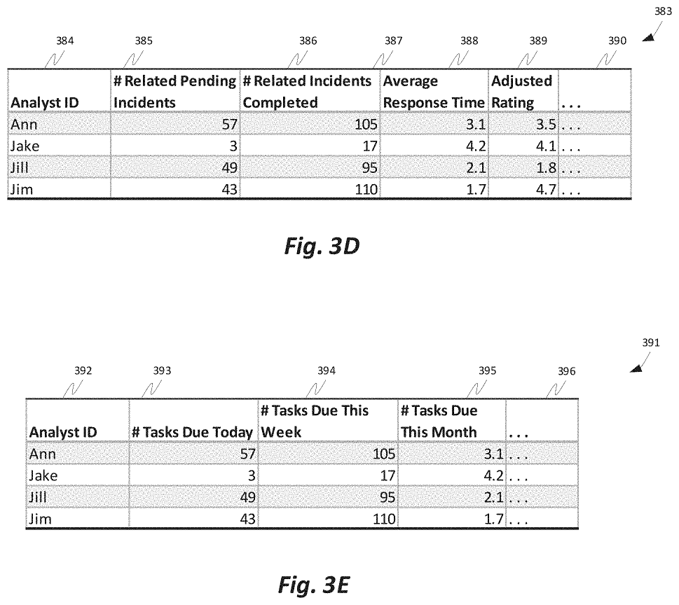

All known information associated with a particular cyber security event may be collected. Such information may be used to generate an incident identifier. An incident identifier may comprise a data packet, csv file, etc. and may be used as a database of all known information associated with the particular cyber security event. A data packet 300 which may be an incident identifier as discussed herein is illustrated in FIG. 3A.

A data packet, or incident identifier, 300 may comprise data such as associated user information 303 for users associated with the incident. For example, the user requesting the cyber security analysis may automatically be added as an associated user. Information identifying the requesting user may be a user ID, an email address, a device IP address, a phone number, etc. Other data associated with an associated user may be saved within the incident identifier, or may be saved in a database accessible to a cyber security analyst. For example, an associated user information filed may be a user ID which may be used by a cyber security analyst (or by a security operation platform) to look up additional user information, such as a phone number, email address, list of associated devices, etc.

An incident identifier 300 may also comprise data used to identify the event 306. For example, upon a request for event analysis or upon detecting a cyber security threat event, a security operation platform may assign an event ID 306. An event ID 306 may be used to look up past events by reference.

An incident identifier 300 may also comprise data associated with an event occurrence timestamp 309. For example, a user requesting analysis of a potential cyber security threat may provide a time and date or an estimated time and date of an occurrence related to the potential cyber security threat. In some embodiments, a security operation platform may detect a potential cyber security threat and log the time of detection as an event occurrence timestamp 309.

An incident identifier 300 may also comprise data associated with associated device information 312. For example, if the analysis is being executed due to a request by a user, the user may provide information identifying the device or devices affected by the suspected threat. As more affected devices are discovered during analysis, the number of entries in the associated device information 312 field may grow. In some instances, the associated device information 312 field may be empty at the beginning of an analysis if no affected device is known.

An incident identifier 300 may also comprise data associated with one or more tags 315. For example, an incident identifier 315 may be tagged with indicators such as “suspicious IP”, “suspicious URL”, “phishing”, “DDoS”, etc. Tags 315 may be added automatically by a security operation platform, or may be added manually by a security analyst. Tags 315 may be used to search through a number of incident identifiers 300 and may be used to find similar incidents. For example, an illustrative user interface display window 350 is illustrated in FIG. 3B.

An incident identifier 300 may also comprise data associated with associated IP addresses 318. For example, each of the known affected devices may be associated with an IP address. Such IP addresses may be listed in the associated IP address 318 field. Other IP addresses may also be listed. Each IP address may also be tagged with additional information, such as “affected device”, “first affected device”, etc. The IP addresses may belong to any network device (or group of network devices) belonging to the local network.

An incident identifier 300 may also comprise data associated with a severity level 321. For example, if the analysis is being executed due to a request by a user, the user may provide information related to an estimated level of severity. The level may be a rating, for example on a scale of one-to-ten. In some embodiments, the severity level may be set automatically by a security operation platform.

An incident identifier 300 may also comprise data associated with security analyst notes 324. For example, if the analysis is being executed due to a request by a user, the user may provide textual information describing the background and circumstances of the security threat. In some embodiments, a security analyst may provide additional notes during analysis. In some embodiments, a security operation platform may automatically add notes based on analysis. In some embodiments, an incident identifier 300 may comprise other data 327.

As illustrated in FIG. 3B, information associated with a number of security threats may be catalogued in a database 350. Each entry 380 may comprise a checkbox 353, an ID number 356, a name entry 359, a security threat type 362, a severity rating 365, a status 368, an owner 371, a playbook 374, and an occurrence timestamp 377. In some embodiments, a database entry may have a greater or lesser number of fields. A database may be stored on a network connected device and may be accessible by a number of security threat analysts. A database may be continuously updated as new threats are identified. Each entry may be updated as new information is discovered about a particular threat. For example, a security analyst may be enabled by the database to view similar threats based on type, severity, occurrence time, owner, etc.

As illustrated in FIG. 3C, a database 381 may comprise a list of incident data entries. An exemplary incident data entry 382 may comprise a number of data fields including, but not limited to, an incident identifier, timestamps relating to incident creation, detection, and completion, known client devices affected by the incident, known networks affected by the incident, contact information associated with the one or more users reporting the incident, a rating of severity of the incident, an owner of the incident, an identification of a device associated with the owner of the incident, one or more experts associated with one or more tasks associated with the incident, one or more playbooks associated with the incident, one or more other incidents associated with the incident, one or more details of the incident, any other fields as may be defined by a user or customer, etc.

With each incident, there may be one or more other incidents which relate to the incident in some way. For example, a number of incidents may be related by a category type, such as a suspicious email incident, or a suspicious file incident, etc. For each group of related incidents, data may be collected in a database 383 as illustrated in FIG. 3D. Such data may include, for example, an indication of which analyst was assigned as owner of each incident, and an indication of the outcome of the incident.

As illustrated in FIG. 3D, a database 383 may comprise a list of analysts and incident data associated with each analyst. An exemplary database 383 may comprise a number of entries with data fields including, but not limited to, an analyst identifier 384, a number of currently pending related incidents associated with each analyst, a number of completed incidents associated with each analyst, an average response time for each analyst based on related incidents, an adjusted rating for each analyst, etc.

As illustrated in FIG. 3E, a database 391 may comprise data for each analyst associated with each analyst's current workload. Such a database 391 may comprise data such as an analyst ID 392 for each analyst, a number of tasks due on the present day 393, a number of tasks due in the present week 394, a number of tasks due in the next 30 days or month 395, etc. In addition to, in the alternative of, a number of tasks, the database may comprise an estimated number of hours of estimated work for each timeframe. For example, some tasks may be estimated to be completed in a generally shorter amount of time compared with other tasks. In addition, some analysts may be more efficient at particular types of tasks. Such factors may be taken into consideration and may be used to complete the data fields in the database 391.

The databases illustrated in FIGS. 3D and 3E may be automatically created and updated with any changes by a security platform as illustrated in FIGS. 1 and 2. During operation of the system, the security platform may, upon detecting any update to the data, update the databases accordingly. Such updates may be performed by the security platform in real time, or periodically.

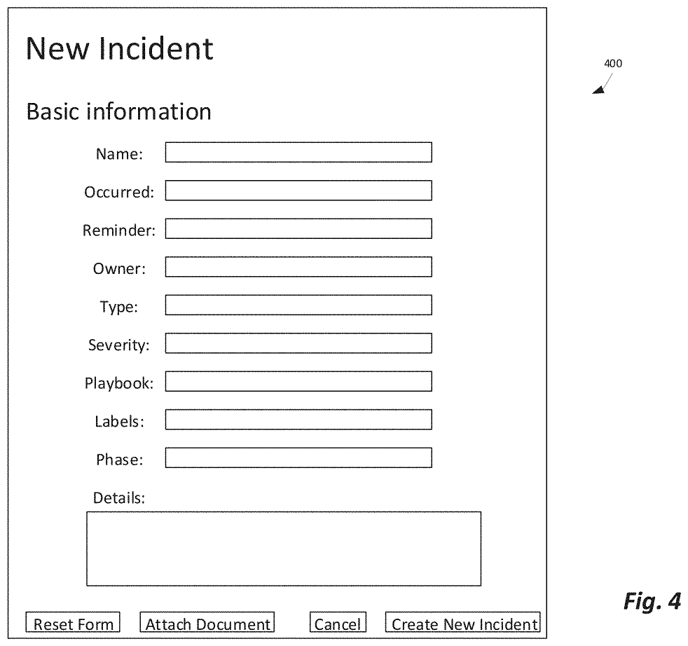

When a user becomes aware of a potential cyber security threat, the user may report the threat to a security operation platform via a form 400 as illustrated in FIG. 4. A form 400 may comprise a user interface displayed on a user device. In some embodiments, a form 400 may provide entry blanks for a user to fill out descriptions of a number of attributes associated with a potential cyber security threat. Information entered into a form 400 may be used to automatically create an entry in a database as illustrated in FIG. 3B.

In some embodiments, a form 400 may comprise entry forms for basic information about a potential cyber security threat such as name of the user, occurrence time and/or date of the threat, a reminder time and/or date, an owner, a type of threat, a severity level, a playbook, a label, a phase, and an entry form for details. In some embodiments, it may be typical for a user identifying a potential security threat to be unable to complete every entry in a form 400. For example, a user may receive a suspicious email. Such a user may decide to report the suspicious email. The user may open a security threat analysis application on the user's device and click a UI button opening a new incident form such as the form 400 illustrated in FIG. 4. Such a user may type the user's name in the form, the day and/or time the suspicious email was received, and may in a details box enter a short description, such as “suspicious email received”. In some embodiments, the form may allow a user to attach a file, such as a .msg file comprising the suspicious email, or an image file showing a screenshot or other relative information associated with the threat.

When details of a potential cyber security threat are received by a security operation platform, the security operation platform may begin a process of analysis of the potential threat. The process of analyzing the potential threat may begin by selecting a playbook from memory. One or more local databases accessible by a security operation platform may be capable of storing a number of playbooks in memory. A playbook may comprise a series of tasks. In some embodiments, a playbook may comprise a workflow for security analysts working with automated processes during a cyber security incident. A playbook may comprise a mix of both manual and automated processes or tasks.

A task in a playbook is typically any piece of an action that could be automated or scripted. Typically when an analyst is dealing with an incident, the analyst will want to go to some of the security products operating on a network server or a client device or elsewhere. They may want to go and simply query and collect information, or they may want to take an action. Each of these steps could be automated. For example, when we look at integrated products, there may be a number of security products integrated into the system. Tasks may be any number of security actions. For example, a task may be one or more of the following:

fetch <security product> search results

search <security product> for events

create new search job in <security product>

print all <security product> index names

update an existing event in <security product>

conduct a web search using <Google or Bing, etc.>

run a query of <security product> and receive results

generate random incidents per given parameter

search known actors based on given parameters

request/receive Intel Report

check [input file/IP/URL] reputation

input [IP address of a file] output: all known client devices containing the file

input [host name or IP] output: all devices associated with that input

input [request for computers running windows XP] output: list of computers running windows XP

input [domain name] output [domain reputation]

input [affected file] output [scanned file results]

add [input file] to blacklist [output: success]p input [name/IP of file] output [all known data, such as publisher, creator, owner, where is it found, is it bad or good, any known associated malware]

input [IP address], output [who registered to, who does it belong to, where is it geolocated, etc.]

A playbook may also comprise one or more conditional tasks in which a question is asked. For example, a first task may comprise a request for a reputation of a domain. A conditional task may ask a reputation question, e.g., if the reputation is bad, then perform task A and if the reputation is good, then perform the task B.

When an incident is created, playbooks may run automatically. When a manual task is initiated, the process along that chain may stop and wait for an input. An analyst may see a manual task, perform it, and input the requested output, or select a complete button.

One analyst may be assigned a number of different incidents. The analyst may not be aware of the automated tasks being performed. Manual tasks from each of the different incidents may appear as they begin on the analyst's terminal. The analyst may simply perform each one and click complete so that each playbook may continue.

One manual task may be answer yes or no and if the security analyst answers yes, the security platform may take one path and if the security analyst answers no, the security platform may take another path. Each playbook may be assigned to a particular analyst.

In some embodiments, the concept of a task may be broad. A task could as simple a step as sending an email, asking a question to another product, calling an API, wiping a system, anything which could be returned by a computer program could be an individual task. In the context of a security program, typically a task is more related to the API actions available in one or more security products. Actions supported by partnered security products via their API.

In some embodiments, a task may comprise the security platform automatically instructing an entity to perform a response action. Response actions may comprise one or more of reimaging an affected device and restoring the affected device from a backup. A response action may, in some embodiments comprise an identity of one or more processes with open connections executing on the affected device.

An input of a task does not need to be the output of the most immediately preceding task. An input of a task could be one or more outputs of one or more of any of preceding tasks. One task may comprise gathering information and such information may not be used in another task until three or more intermediate tasks have executed. As playbooks become more complex, for example a playbook comprising fifty or more tasks, if all outputs of all tasks are displayed to a user creating a new task as possible inputs, the design of the system may become overly complicated. Instead, the number of inputs visible to a user adding a task may be limited to only those outputs of preceding tasks within the new task's chain. So an analyst creating or editing a playbook may be assisted by the security platform pre-calculating possible tasks and flows for the playbook. Real-time calculations of the path may be made as the playbook is edited. Pre-filtering the list of options available for the user to choose based on real-time path calculation in the playbook may enable a more efficient workflow to be created.

A process, or task, may comprise the security operation platform requesting specific data from a network source. In some embodiments, certain tasks may be automated. For example, when a task is repeated and/or does not require human intervention, the security operation platform may automatically perform the task and retrieve data to update an incident identifier. Using retrieved data, the security operation platform may continue to perform additional tasks based on one or more playbooks. Automated tasks may comprise checking a reputation of an entity, querying an endpoint product, searching for information in one or more network locations, sending emails requesting data from users, making telephone or VoIP phone calls requesting data, and other potentially automated processes.

In some embodiments, certain tasks may be completable only by a human user. For example, if a task requires speaking with a user or otherwise collecting data not accessible via a network, the security operation platform may instruct a human security analyst to perform a task. While waiting for input from the security analyst, the security operation platform may either proceed to perform other tasks or may simply pause the process until input is received.

Each process may result in a modification to the following processes. For example, an output of a first process may be an input to a second process. The workflow of a playbook may follow a particular path based on an output of a task, for example the workflow may depend on a number of if-this-then-that statements.

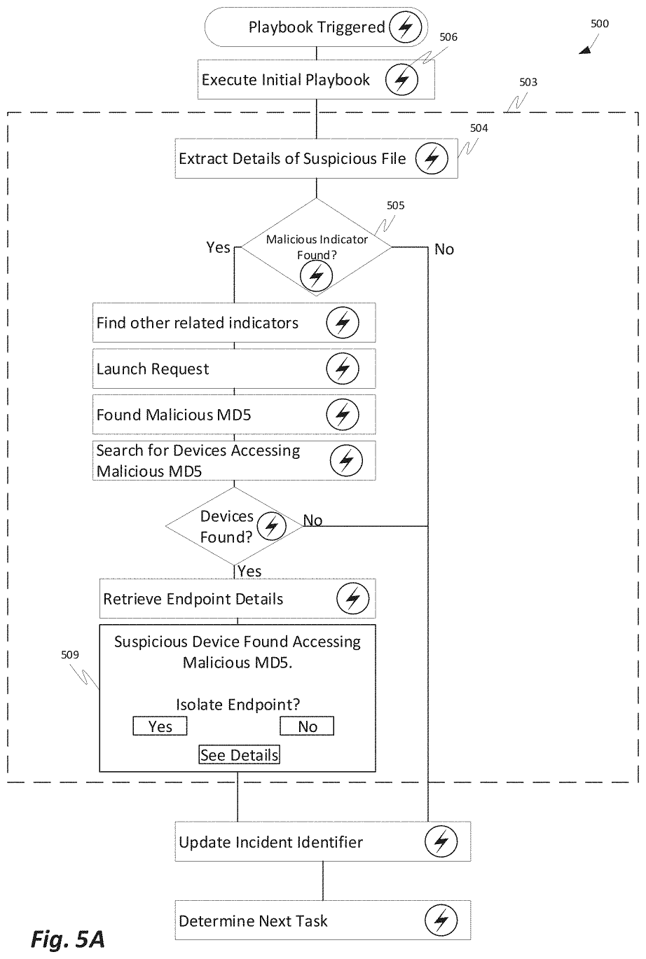

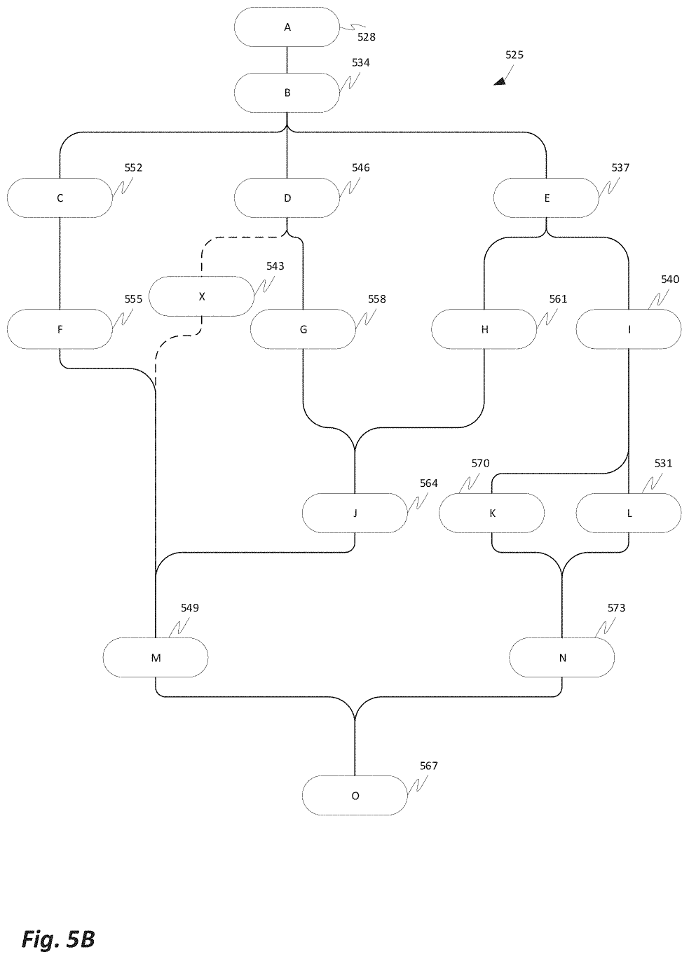

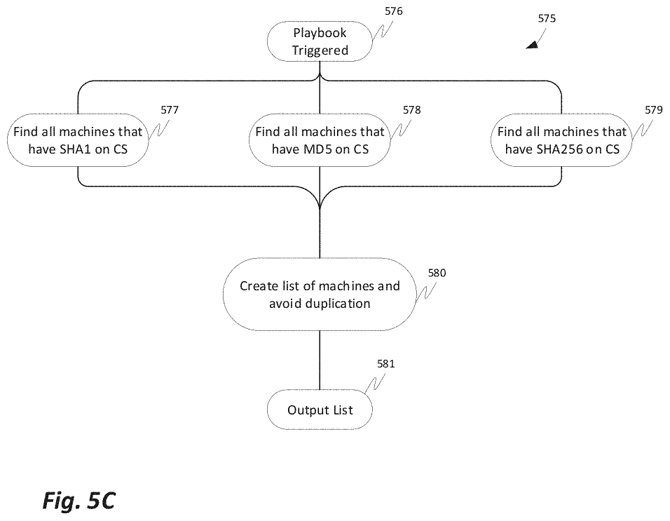

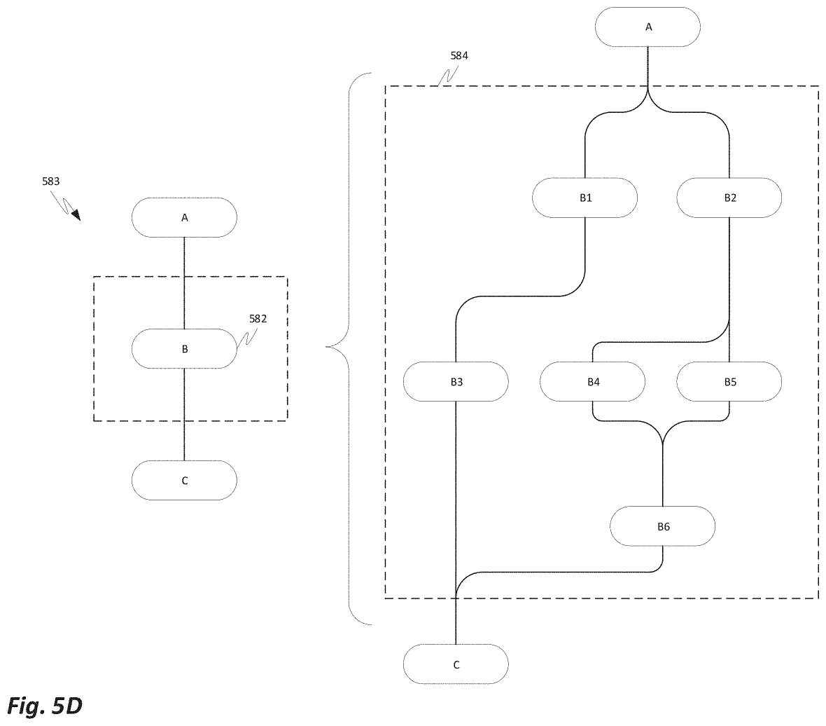

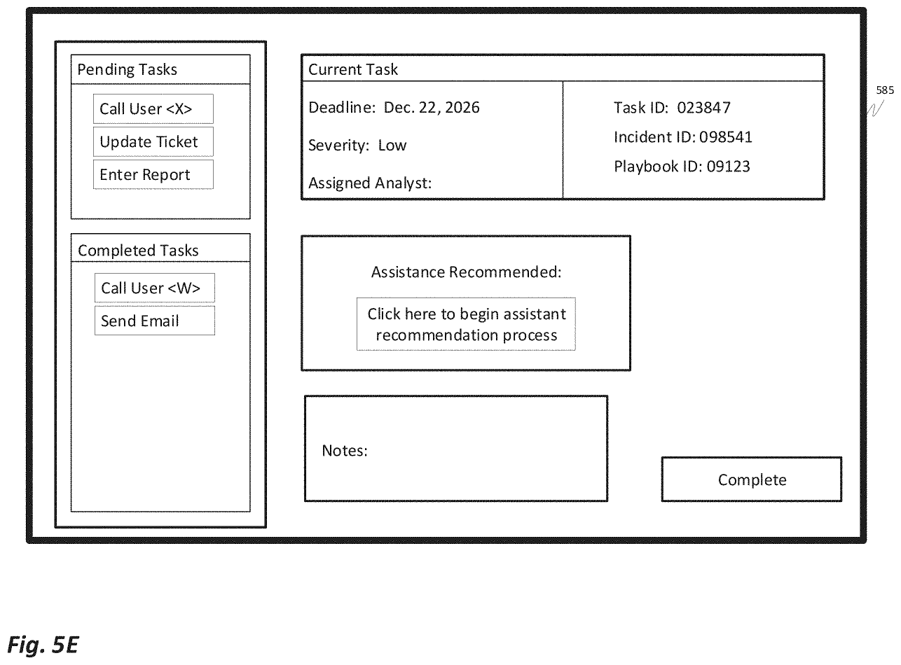

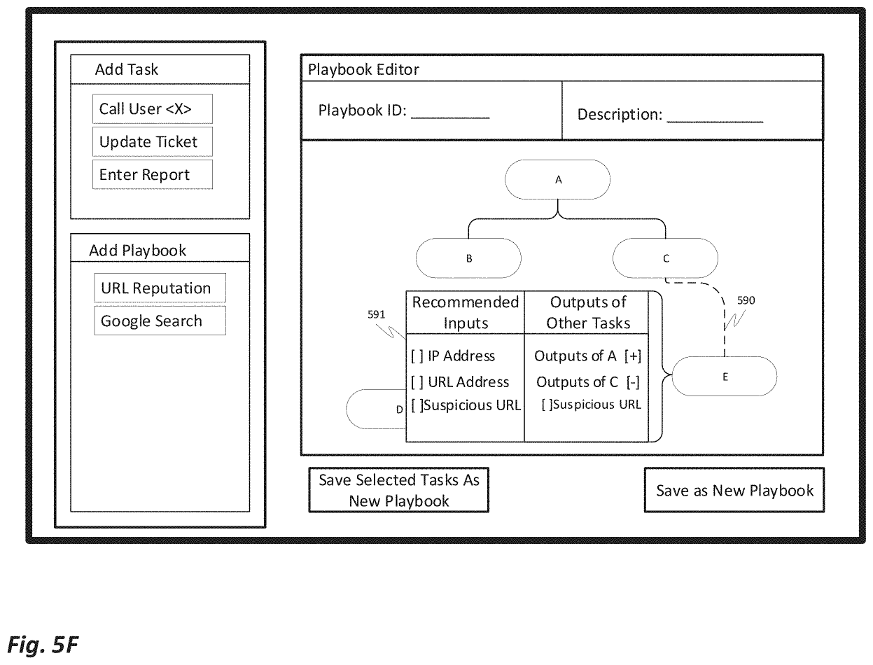

As illustrated in FIG. 5A, a playbook may be represented by a user interface visualization 500 presented on a user interface of a security analyst terminal. Note that the tasks listed in the playbook illustrated in the figures are example tasks only. Each playbook or task may begin with the playbook or task being triggered. When a user request for analysis of a potential security threat is received, or when a potential security threat is detected by a security operation platform, a playbook may be triggered. In the case of a task, the task may be triggered when all tasks preceding the immediate task have been completed.

In general, all tasks have inputs and generate outputs. Many playbooks may also accept or expect inputs.

When a playbook is triggered, a window on a security analyst terminal may present a flowchart or other representation of the tasks to be executed. As discussed herein, one playbook may comprise a number of playbooks and/or tasks. One such playbook comprising a number of tasks is represented by the rectangular dotted line 503 in FIG. 5A. Each entry in a playbook may represent a task. Each task may be automated or may require human interaction. A security analyst viewing the visualization of the playbook may be shown a symbol 506 indicating whether a task is automated. If a non-automated task is executed, a window 509 may be displayed within the visualization 500 to an analyst allowing for input.

In the example of FIG. 5A, the playbook 500 may be triggered which may cause an initial playbook to execute. The initial playbook may comprise a number of tasks, for example gathering affected user info or affected client device info. The initial playbook may also comprise receiving a quarantined suspicious file. Such tasks may be automated, manual, or a mix of automated and manual tasks. Automated tasks may be performed by a processor of a computing device, or security platform. Automated tasks may be performed in the background of a security analyst terminal. Manual tasks may comprise displaying instructions on a user interface of a security analyst terminal to be performed by a security analyst.

A playbook may have an output. The output of the initial playbook may be a suspicious file. Tasks or playbooks may comprise gathering data, such as suspicious files, user information, etc., and storing such data in a network location accessible to the security platform. Such data may be used in future tasks as inputs.

In the example of FIG. 5A, when the initial playbook has completed, the suspicious file gathered in the initial playbook may be used as an input to the next step 504. The next step 504 may comprise a processor of the security platform calling an API of a security product to extract details of the suspicious file. While many details of the suspicious file may be extracted in the step 504, not all may be inputs to following tasks. Continuing the example of FIG. 5A, the following step 505 may be a conditional task in which it is determined whether a malicious indicator was found among the details of the suspicious file.

In some embodiments, a playbook 525 may comprise a flowchart of one or more tasks or other playbooks as illustrated in FIG. 5B. A playbook 525 may comprise a first task or playbook 528, labeled in FIG. 5B as ‘A’. Note that any of the tasks of a playbook may comprise a number of other tasks. In general, a task will expect a particular piece or set of data in order to operate and will, in general, output one or more data points.

In some embodiments, a first task 528 may comprise a determination that all required inputs for the playbook to execute are accessible to the computer system executing the playbook. As an example, one playbook may be designed to send an email to all users of a particular type of client device alerting those users to a potential security threat. Such a playbook may require one or more pieces of data in order to begin, such as information associated with all users on a computer system, or IP addresses of all client devices, etc. Alternatively, such a playbook may require only an identity of a computer network and an identity of a cyber security threat. Other needed data may be collected via one or more tasks within the playbook before the emails are sent.

Tasks can be any action which can be automated or scripted. For example, querying a data source on a network or taking another action such as automatically drafting an email to be edited and/or sent by a security analyst. A task may comprise automatically searching a web browser search utility such as Google for a particular word, or may comprise wiping an affected system.

In some embodiments, client devices connected to the computer system may be executing one or more security computer program products. A security system as discussed herein may be designed such that security products on client devices can be queried to collect data gathered by the security products. For example, the security system discussed herein may be capable of utilizing APIs of a number of different security products on computer network objects existing across a network to gather data needed for one or more tasks.

A playbook may comprise a chain of tasks, wherein each task may accept as input one or more data points gathered in one or more of the previous tasks in the chain. To illustrate, in FIG. 5B, a task ‘L’ 531 may be capable of using data output from one of tasks ‘A’ 528, ‘B’ 534, ‘E’ 537, and ‘I’ 540. A playbook may be designed such that a task may never require input gathered from a task which is not a preceding task. For example, in FIG. 5B, task ‘L’ 531 may be designed such that no data gathered outside the chain of tasks ‘A’ 528, ‘B’ 534, ‘E’ 537, and ‘I’ 540 is needed to execute the task 531.

As such, execution of a task may stall until all preceding tasks have been completed. In the case of automated tasks, the system may make a determination that the proper output of a task has been received before moving to a following task. In the case of manual tasks, the system again may determine that the proper output of a task has been received before moving to a following task, or the system may rely on a security analyst to report to the system that a task has been completed.

In some embodiments, a security analyst may be enabled to quickly edit a playbook by simply adding tasks to an existing playbook. For example, as illustrated in FIG. 5B, a security analyst may take an existing playbook—as illustrated by those tasks in solid lines—and add a new task—illustrated by the dotted line task 543. Such a security analyst may place the new task 543 below task ‘D’ 546, indicating that the new task 543 should execute only after task ‘D’ 546 completes. The security analyst may draw a line as illustrated in FIG. 5B down from the new task 543 to the input of task ‘M’ 549. By adding the new task 543 as an input to task ‘M’ 549 of the existing playbook, the security analyst may ensure that task ‘M’ 549 will not execute until the data collected in task 543 is output by the system. Note that task ‘M’ 549 may also not execute until all of tasks ‘A’ 528, ‘B’ 534, ‘C’ 552, ‘D’ 546, ‘E’ 537, ‘F’ 555, ‘G’ 558, ‘H’ 561, ‘J’ 564, and the new task 543 have output the expected data points. Similarly, task ‘O’ 567 may not execute until all of tasks ‘A’ 528, ‘B’ 534, ‘C’ 552, ‘D’ 546, ‘E’ 537, ‘F’ 555, ‘G’ 558, ‘H’ 561, ‘I’ 540, ‘J’ 564, ‘K’ 570, ‘L’ 531, ‘M’ 549, ‘N’ 573 and the new task 543 have output the expected data points. In some embodiments, there may be fail safe systems such that in the event a particular data point cannot be gathered, for whatever reason, the system may carryon in the absence of such a data point.

An example playbook 575 is illustrated in FIG. 5C. The playbook may be triggered 576 upon any number of events. For example, a task of another playbook may detect a particular potential security threat and, upon such a detection, the task may trigger the playbook of FIG. 5C. In some embodiments, a security analyst may determine the playbook of FIG. 5C is needed for the analysis of a particular cyber security threat. The playbook illustrated in FIG. 5C may be designed to generate and output a list of machines on a computer system having one or more of SHA1, MD5, and/or SHA256. The input to the system may comprise an identity of a computer system.

Upon the playbook being triggered 576, the example playbook 575 may execute three tasks in parallel as illustrated by tasks 577, 578, 579. In the example of FIG. 5C, the three parallel tasks may comprise a task 577 of finding all machines that have SHA1 on the input computer system, a task 578 of finding all machines that have MD5 on the input computer system, and a task 579 of finding all machines that have SHA256 on the input computer system.

The task 580 may not execute until either all three tasks 577, 578, 579 have executed to completion or fewer than all three if it is detected that one of the three previous tasks could not be executed. The tasks 577, 578, 579 may each be automated tasks, automatically finding the machines, or one or more of the tasks 577, 578, 579 may be a manual task. Each one of the three tasks 577, 578, 579 may output a list which may be used as an input to the task 580. Task 580 may also use as an input any input to the playbook 575 as well as any output of the first task 576. In the example of FIG. 5C, task 580 comprises taking the lists output from tasks 577, 578, 579 and creating a list of machines having one or more of SHA1, MD5, and/or SHA256 on the computer system and reducing the list such that there is no duplication. Following the completion of task 580, the playbook may comprise outputting the list 581.

As illustrated in FIG. 5D, one element 582 of a playbook 583 may comprise another playbook 584. As a playbook may have one or more inputs and provide one or more outputs, a playbook may be very complex or simple. A task of a playbook may comprise one or more automated tasks as well as one or more manual tasks, or a task may comprise one or more solely automated or manual tasks. In the example of FIG. 5D, the task 582 may comprise the playbook 584. By representing an entire playbook as one task, new and complex playbooks may be created by a security analyst quite quickly without requiring each sub-task to be planned.

As some tasks, and some entire playbooks, may be automated, the processing of automated tasks may run in the background of the security platform system. A security analyst assigned to a particular security threat may not have a need to spectate the playbook operation and may only see those tasks which require manual input. Moreover, one security analyst may be assigned a number of potential security threats or incidents.

Such a security analyst may have a security analyst terminal, or PC, with a user interface 585 as illustrated in FIG. 5E. As can be appreciated, a security analyst terminal user interface 585 may display one or more pending tasks assigned to the security analyst as well as one or more tasks completed by the security analyst. A security analyst at the security analyst terminal may be capable of selecting a pending task and the user interface 585 may display information about the selected task. Information about the selected task may comprise information such as a deadline timestamp for the security analyst to complete the task, a severity of the task, an assigned analyst ID, a task ID, an incident ID, a playbook ID, as well as instructions for completing the task and buttons to input the information needed by the task. The user interface 585 may also allow for a security analyst to input notes associated with completing the task which may be saved in a report associated with the incident.

The user interface 585 may also at times comprise a display informing a cyber security analyst that a recommendation that an assistant for a present task should be assigned has been made by the security platform. The user interface 585 may in such times allow a cyber security analyst to initiate such a recommendation process.

A security analyst may be capable, using a security platform, to create a task or playbook either from scratch or from other tasks or playbooks. For example, a security analyst may create a playbook from a number of existing tasks by dragging and dropping tasks into a playbook creator user interface as illustrated in FIG. 5F. Lines may be drawn by a security analyst into a task from another task indicating an order of operation. When a new line is drawn from the bottom of a task into the top of another task, the creating user may be shown a display of available inputs. For example, as illustrated in FIG. 5F, new task E has been added to the playbook. Line 590 may be drawn from task C into task E. A window 591 may pop up as the line 590 is drawn. As the line 590 is drawn out of C, all outputs of C as well as the outputs of A, being prior to tasks C and E, should be available as inputs to task E. The window 591 may allow a user to select from those outputs to decide on an input to the new task E. The window 591 may also allow for a user to select from one or more recommended inputs. Inputs may be recommended by the security operation platform based on a number of factors, such as popularity, past success rate, current situation, or other relevant factors.

The available inputs may comprise all outputs of all tasks or playbooks above the new lower task. In this way, it may be ensured that the playbook will never need a data point from a task that has yet to be executed. That is, by the time the new task has begun, all previous tasks will have executed and thus all requisite inputs for the task will have been gathered.

A security analyst may also be capable of selecting a number of tasks and saving them as a new playbook. Such a playbook, comprising any number of tasks, may be represented as a simple task, as illustrated in FIG. 5D. Such representation may enable security analysts to build increasingly complex playbooks without requiring every single task to be selected with each new playbook.

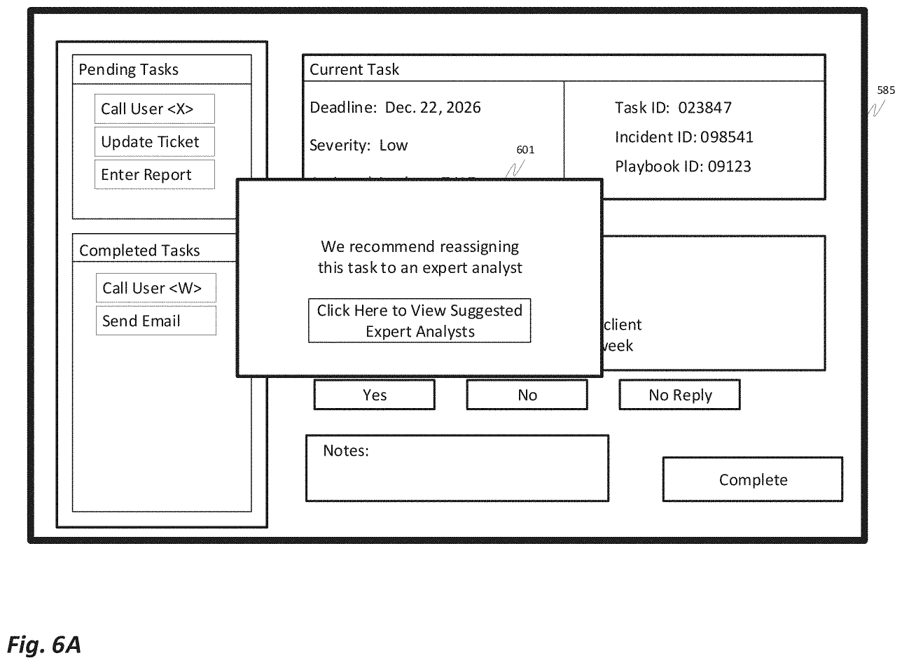

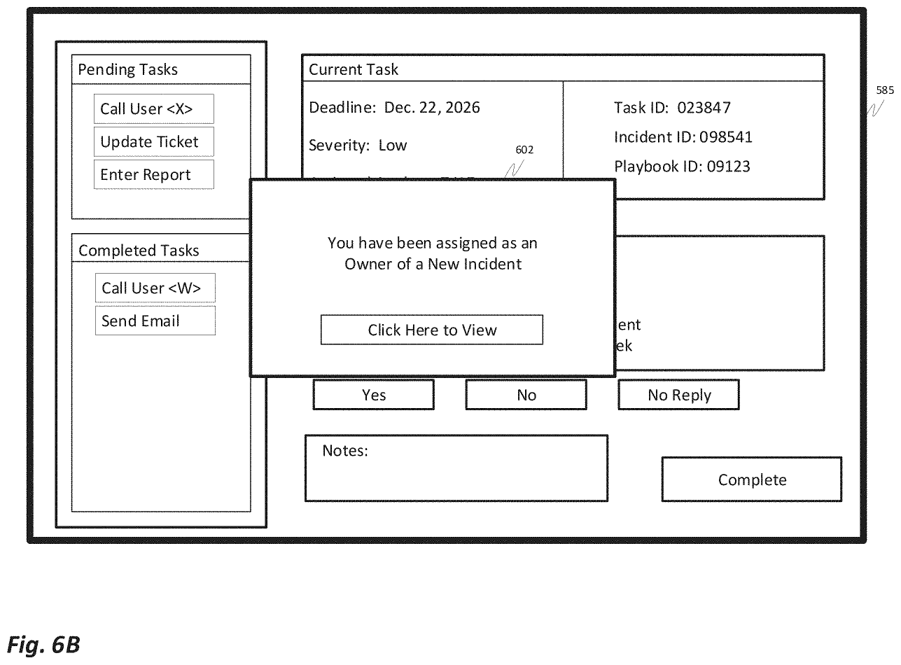

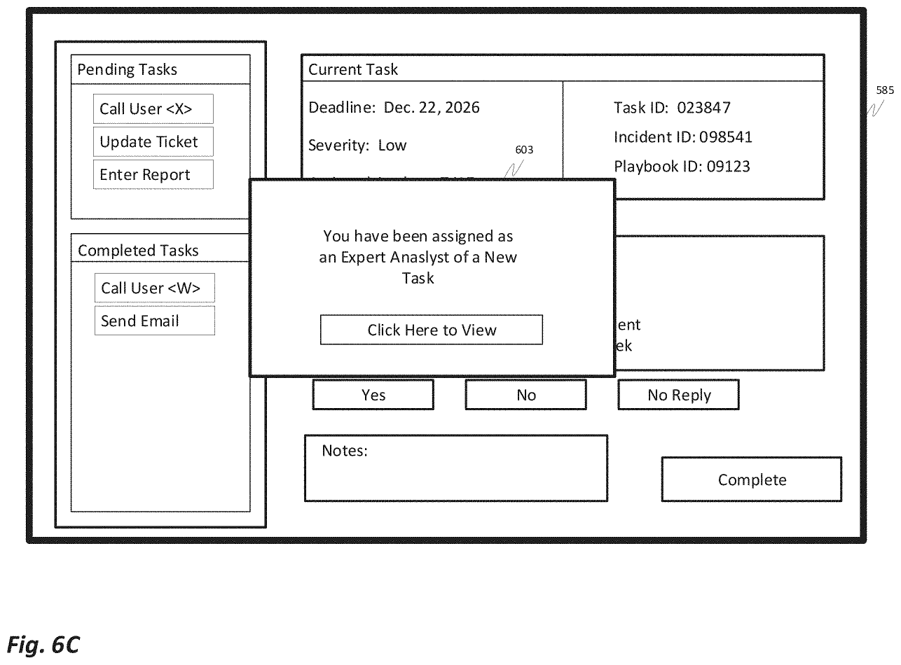

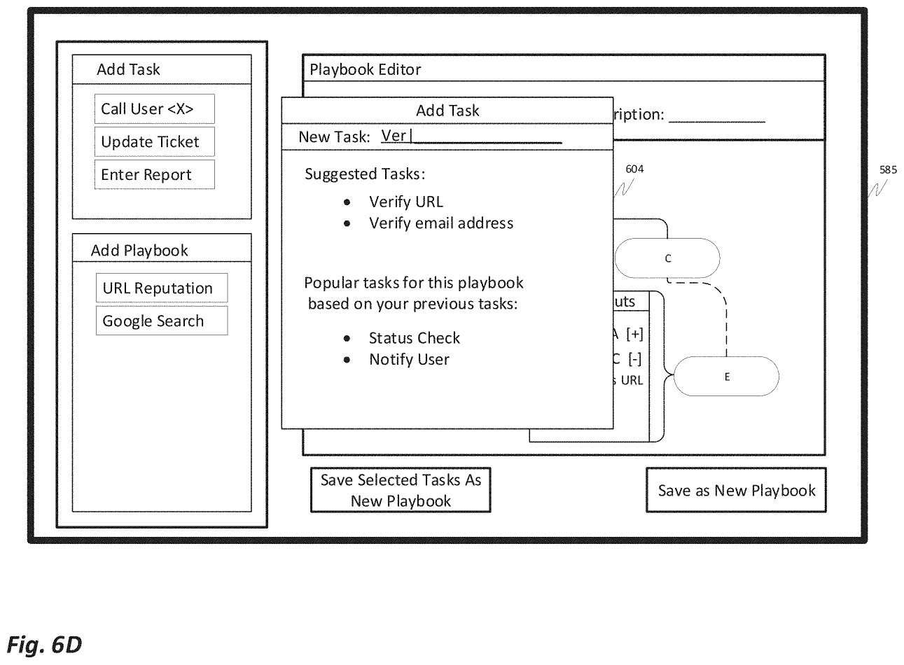

As illustrated in FIG. 6A, a user interface 585 may at times comprise a window 601 informing a cyber security analyst viewing the user interface 585 that a recommendation of reassigning a present task to an expert analyst has been made by the security operation platform. The window 601 may allow for input to be received from the cyber security analyst viewing the user interface 585. The cyber security analyst may be allowed to view one or more suggested expert analysts via the user interface 585.

As illustrated in FIG. 6B, a user interface 585 may at times comprise a window 602 informing a cyber security analyst viewing the user interface 585 that the cyber security analyst has been assigned as an owner of a new incident by the security operation platform. The window 602 may allow for input to be received from the cyber security analyst viewing the user interface 585. The cyber security analyst may be allowed to view details of the newly assigned incident via the user interface 585.

As illustrated in FIG. 6C, a user interface 585 may at times comprise a window 603 informing a cyber security analyst viewing the user interface 585 that the cyber security analyst has been assigned as an expert analyst of a task of an incident owned by another cyber security analyst by the security operation platform. The window 603 may allow for input to be received from the cyber security analyst viewing the user interface 585. The cyber security analyst may be allowed to view details related to the newly assigned task via the user interface 585.

As illustrated in FIG. 6D, a user interface 585 may at times comprise a window 604 allowing for a cyber security analyst viewing the user interface 585 to create a new task or add a new task to a playbook. The window 604 may have a text input box allowing for the cyber security analyst to type in a name for the new task. The window 604 may additionally display one or more suggested tasks based on the current playbook and/or current incident. The window 604 may further comprise one or more popularly chosen new tasks based on one or more tasks previously performed on the current incident based on tasks performed by one or more analysts working on similar tasks in the past. Such suggested and/or popular tasks may comprise verifying a URL, verifying an email address, checking a status, notifying one or more users, etc.

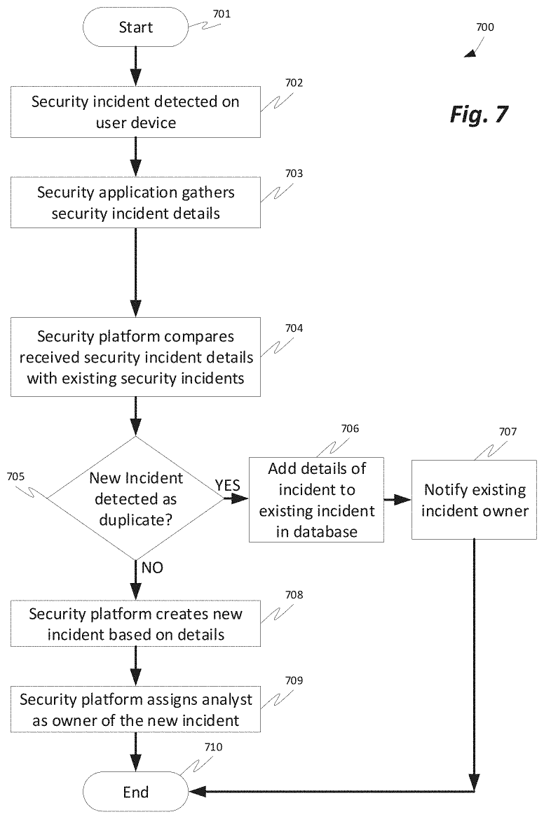

An illustrative method 700 of automatically assigning a cyber-security analyst as an owner of a cyber-security incident by a security operation platform in accordance with some embodiments is illustrated in FIG. 7. At the start 701 of the method 700, a system as illustrated in FIG. 1 may be in operation. At step 702, a cyber-security incident may be detected on a user device. In some embodiments, a user may be a user of a computing device 127 of a local network 103 or may be a remote user 136 as illustrated in FIG. 1. The device may be a laptop, a desktop computer, a smartphone, a tablet, etc. In some embodiments, the cyber-security incident may be detected on a number of devices on a number of different networks. For example, a user may first download a suspicious file on his or her laptop of a worksite computer network. The user may later or simultaneously download the same or a similar file to his or her smartphone via a wireless connection to a different network. Such occurrences may be events relating to a single cyber-security incident.

At step 703, details of the cyber-security incident may be gathered by an application executing on a security operation platform 106 as illustrated in FIG. 1. Such data gathering may comprise and/or be initiated by the security operation platform 106 receiving a new incident information form as illustrated in FIG. 4 from one or more users detecting the cyber-security incident. The data gathered may comprise information received in the new incident information form. The data may comprise, as illustrated in FIG. 4, a name of the reporting user, a date or time of occurrence of the incident, a type of incident, an estimated rate of severity of the incident, one or more labels, etc. The data may additionally describe a written description of the incident based on the identifying user's experience.

At step 704, the security operation platform may analyze the gathered details of the detected incident. The security operation platform may compare any accessible information associated with the detected incident to information related to other tasks accessible to the security operation platform. For example, the security operation platform may compare the received detected incident details with details of other incidents in databases stored in memory. The databases stored in memory may be as illustrated in FIGS. 3B and 3C.

At step 705, the security operation platform may, based on its analysis of the gathered details relating to the detected incident and its comparison of the gathered details relating to the detected incident with information on other incidents in databases stored in memory, determine if the new incident has already been detected and is merely a duplicate of an incident already existing as an entry in a database as illustrated in FIG. 3C.

If the incident is detected as a duplicate in step 705, the security operation platform may, in step 706, determine if any additional information has been gathered regarding the duplicate incident that was not already existing in memory. Any such additional information may be added as details of the existing incident in one or more databases in memory. Next, in step 707, the owner of the existing incident may be notified of the newly reported security incident and any additional data gathered regarding the existing incident. The owner may be notified via message sent from the security operation platform 106 to a user interface as illustrated in one or more of FIGS. 6A-6D of a security analyst device 130 associated with the owner. After notifying the owner of the existing incident, the method 700 may end at step 710.

If, on the other hand, the incident is not detected as a duplicate in step 705, the security operation platform may, in step 708, create a new incident entry in one or more databases in memory based on the detected incident. The new incident entry may comprise any or all of the data gathered by the security operation platform. The new incident entry may be as illustrated in FIGS. 3A-C.

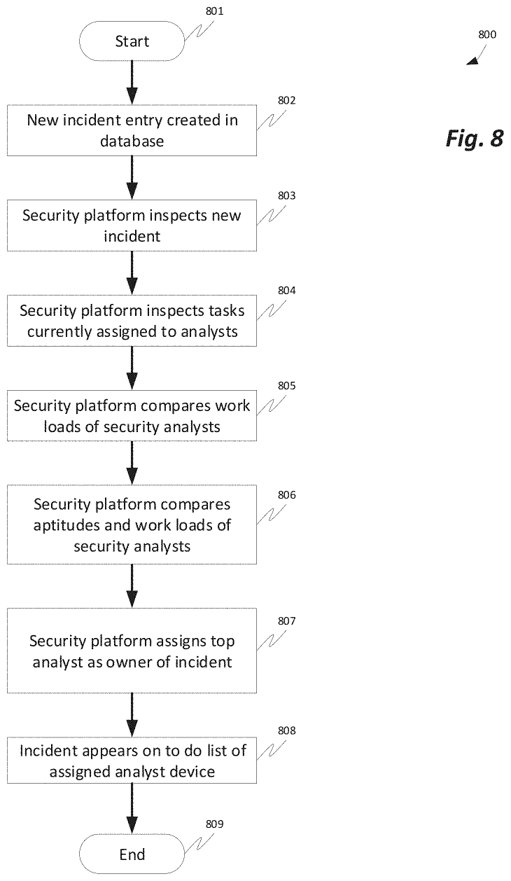

Upon creating a new incident entry in one or more databases stored in memory, the security operation platform may, in step 709, assign a security analyst as an owner of the incident. This assignment may be performed by the security operation platform as described below with regards to FIG. 8. The assignment of the owner of the new incident may also be recorded by the security operation platform along with the new incident entry in one or more databases in memory. After assigning a cyber-security analyst as an owner of the new incident, the method may end at step 710.

An illustrative method 800 of automatically assigning a cyber-security analyst as an owner of a cyber-security incident by a security operation platform in accordance with some embodiments is illustrated in FIG. 8. At the start 801 of the method 800, a system as illustrated in FIG. 1 may be in operation. At step 802, a new incident entry may be created in one or more databases as discussed above in the description of FIG. 7.

At step 803, the security operation platform may inspect and/or analyze all information existing in memory associated with the incident. Step 803 may comprise determining, by the security operation platform, one or more categories associated with the incident. Categories may be determined by the security operation platform based on information stored in memory associated with the incident. Such information may include, for example, an incident type, a related file, identities of devices affected by the incident, etc.

At step 804, the security operation platform may read one or more databases stored in memory comprising incident data associated with one or more security analysts to determine which tasks have been assigned to which analysts. Data, for example as illustrated in FIG. 3D, may be read by the security operation platform. The security operation platform may analyze a particular database associated with incidents related to the new incident. For example, the security operation platform may determine one or more of a number of similar databases, wherein each of the number of similar databases is associated with a different type or category of incident. As an example, the new incident may be related to a suspicious email. The security operation platform may perform a lookup on a database of statistics for a number of cyber security analysts in which the data particularly relates to suspicious email incidents. The data read by the security operation platform may comprise, among other data fields, a number of currently pending related incidents for each analyst, a number of completed related incidents, an average response time for each analyst, a rating for each analyst adjusted for the particular incident type, and other relative information. Based on the data read from the one or more databases, the security operation platform may determine an aptitude of each analyst for the type of incident associated with the new incident.

In step 805, the security operation platform may read one or more databases stored in memory comprising work-load data associated with one or more security analysts. As an example, a database as illustrated in FIG. 3D may be read. The data read by the security operation platform may comprise fields such as a number of tasks due on the present day, a number of tasks due during the present week or next seven days, and/or a number of tasks due in the present month and/or the next thirty days. As described above, the data read by the security operation platform may additionally or alternatively comprise data related to an estimated amount of time required for tasks assigned to each analyst over each time period.

In step 806, the security operation platform may compare work loads of security analysts read from memory in step 805 with an aptitude of each analyst for the type of incident associated with the new analyst. The aptitude may be determined from the data read from memory in step 804.

In step 807, based on the comparison of the work loads and aptitudes for each security analyst, the security operation platform may determine an optimal security analyst to assign as an owner of the task. The assignment may be determined based on workload and aptitude factors for each analyst. The workload and aptitude factors may be weighted differently based on particular scenarios. In some embodiments, a light workload may be a primary factor in assigning the optimal owner. In some embodiments, a high aptitude score for the incident type may be a primary factor. The weight of the factors may depend on the type of incident being assigned an owner. After assigning an owner, the security operation platform may record the assignment in a database in memory and may update a workload database reflecting the assignment.

In step 808, after assigning an owner to the incident, the security operation platform may send a notification to a security analyst device 130 associated with the security analyst being assigned as an owner. The notification may be displayed as illustrated in FIG. 6B on a display of the security analyst device.

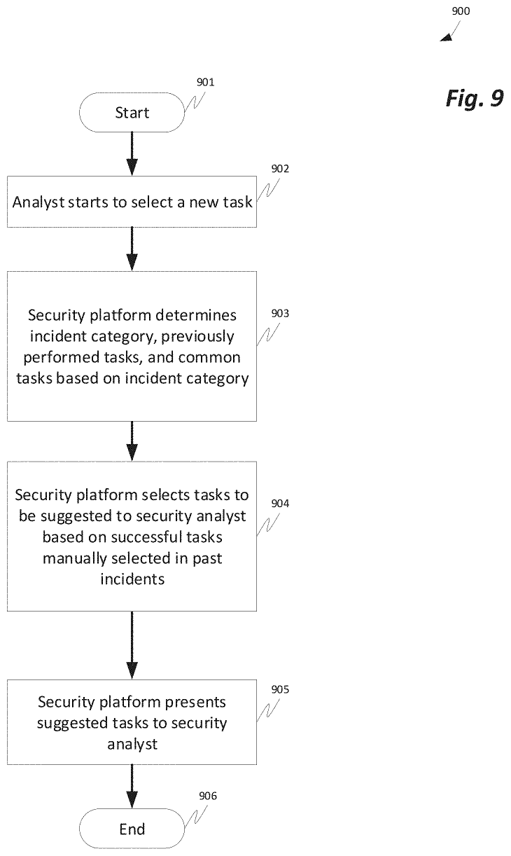

An illustrative method 900 of suggesting tasks to a security analyst by a security operation platform in accordance with some embodiments is illustrated in FIG. 9. At the start 901 of the method 900, a system as illustrated in FIG. 1 may be in operation. One or more cyber security analysts may be working at one or more cyber security analyst devices. For example, a cyber security analyst may be performing tasks associated with a particular incident to which he or she is assigned as an owner.

At step 902, a cyber security analyst may use a user interface of a cyber security analyst device to begin to select a new task and/or playbook to perform for a particular incident. The step may comprise the analyst clicking on a new task and/or a new playbook button. A window may be displayed to the analyst. The window may have a text input box allowing the analyst to type in a command and/or name of a task and/or playbook.

At step 903, the security operation platform may detect the cyber security analyst beginning to select a new task to perform for the incident. In response to the detection, the security operation platform may determine one or more categories associated with the incident. The security operation platform one or more tasks which were previously executed by the cyber security analyst for the event.

Based on the determined one or more categories associated with the incident and the one or more tasks previously executed by the cyber security analyst, the security operation platform may also determine one or more tasks which have been commonly performed by other analysts faced with a similar situation.

At step 904, the security operation platform may select one or more tasks and/or playbooks to be suggested to the cyber security analyst. The selection may be made by the security operation platform based on a success score or other qualities of the determined one or more tasks which have been commonly performed by other analysts faced with a similar situation.

At step 905, the security operation platform may generate a notification to be sent to the cyber security device comprising the selected one or more tasks and/or playbooks to be suggested to the cyber security analyst. The cyber security device may present such suggestions to the cyber security analyst via a display window. At step 906 the method 900 may end.

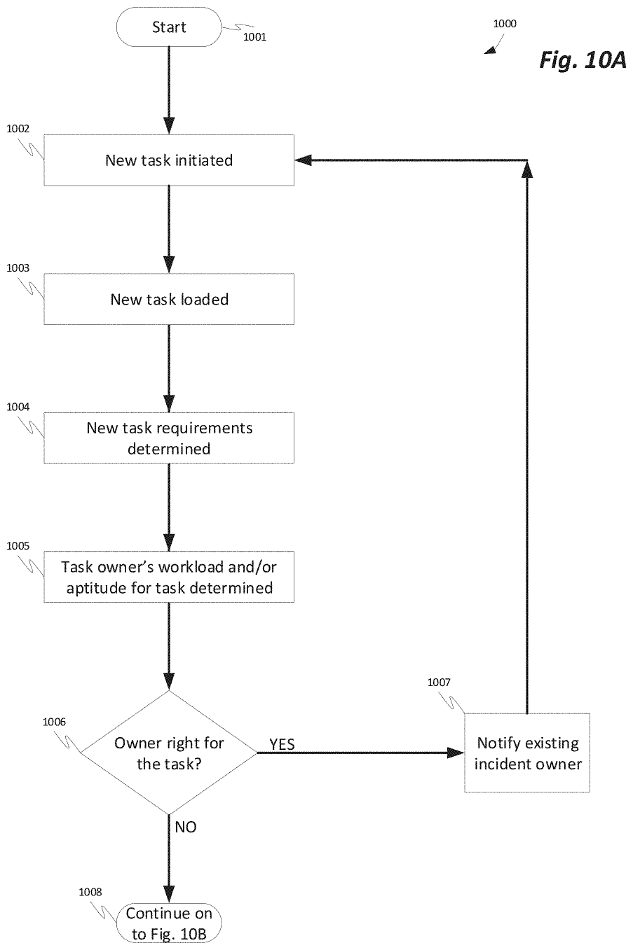

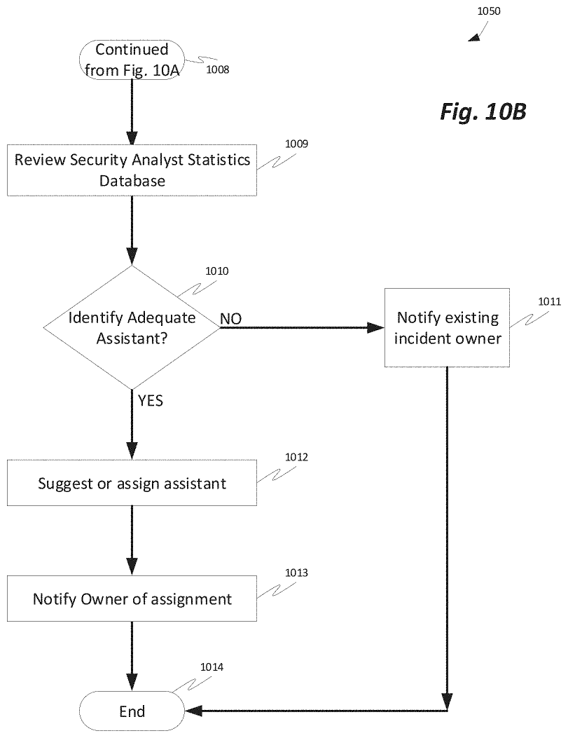

An illustrative method 1000, 1050 of assigning an expert to a task by a security operation platform in accordance with some embodiments is illustrated in FIGS. 10A and 10B. At the start 1001 of the method 1000, 1050, a system as illustrated in FIG. 1 may be in operation. At step 1002, a new task may be initiated on a security analyst device.

At step 1003, the security operation platform may determine the new task has been initiated. The security operation platform may load the new task and, at step 1004, requirements of the new task may be determined. Requirements of the new task may comprise factors such as a minimum aptitude of the assigned analyst, a minimum number of related tasks performed by the assigned analyst, a turnaround times for the task, and/or other factors.

At step 1005, the task owner's workload, aptitude for the task, and/or other qualities may be determined.

At step 1006, the security operation platform may determine whether the owner is right for the task.

If the security operation platform determines, in step 1006, the owner of the incident is right for the task, the method may continue with step 1007. At step 1007, the incident owner may be notified and instructed to continue executing the task. The method may return to step 1002 and the security operation platform may wait for a new task to be initiated.

If, in step 1006, the security operation platform determines the owner of the incident is not right for the task, the method may proceed to step 1008. At step 1008, the method continues to FIG. 10B and on to step 1009 in FIG. 10B.

At step 1009, the security operation platform may review one or more databases comprising statistics associated with one or more security analysts other than the assigned analyst. The databases reviewed by the security operation platform may comprise data associated with workloads, aptitudes for the task type, and/or other factors.

At step 1010, the security operation platform may determine if any of the security analysts other than the assigned analyst can be identified as being an adequate analyst for the task.

If, in step 1010, an adequate analyst cannot be identified, the method may continue to step 1011. At step 1011, the existing incident owner may be notified that no adequate analyst has been identified, and the method may end at step 1014.

If, in step 1010, an adequate analyst can be identified, the method may continue to step 1012. At step 1012, the adequate analyst may either be suggested to the incident owner or automatically assigned to the task as an expert.

At step 1013, the owner of the incident may be notified of the suggestion to the expert or assignment of the expert.

At step 1014, the method may end.

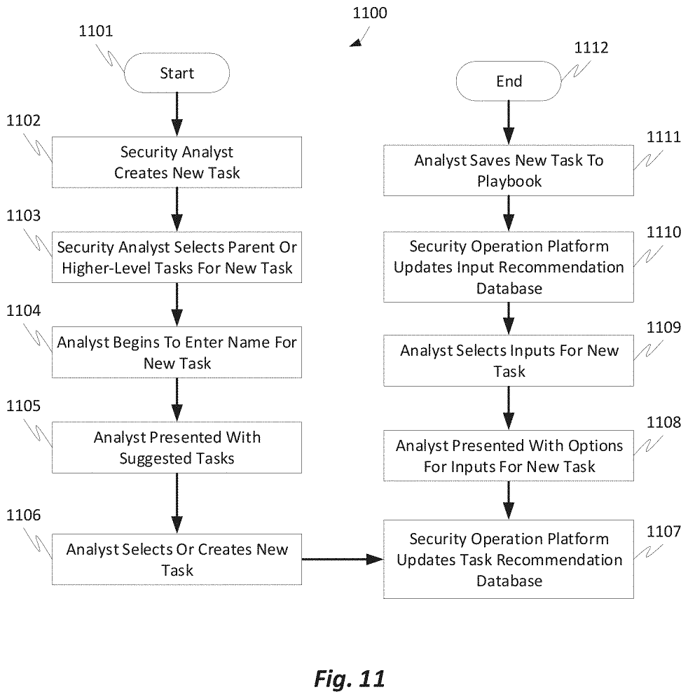

As illustrated in FIG. 11, a security operation platform may be capable of implementing a method 1100 of autonomously assisting users in the creation and editing of tasks in a playbook. The method 1100 may be implemented in conjunction with the playbook editor feature as illustrated in FIGS. 5F and 6D. The method may begin at step 1101 at which point a security analyst using a security analyst device as illustrated in FIG. 1 may communicate with a security operation platform. The security analyst may open a playbook editor and select a particular playbook or create a new playbook.

At step 1102, the security analyst may create a new task in the playbook. Creating a new task in a playbook may comprise opening a playbook editor application and selecting an “add task” button. The method 1100 may also be used when a security analyst edits an existing task in a playbook.

At step 1103, the security analyst may select one or more other tasks as parents of the new task, or as higher-level tasks. This selection organizes the workflow of the playbook. The selection may be illustrated in the UI of the playbook editor as shown by the line 590 in FIG. 5F. As illustrated in FIG. 5F, a security analyst has chosen task C to be a parent of the new task E. While only one parent task is illustrated for the new task E in FIG. 5F, it should be appreciated that a task may have multiple, or no parent tasks. As described herein, a task may not begin to be executed until all preceding tasks have been executed. For this reason, the selection of the parent tasks for a particular task determines the inputs which may be available for the task.

At step 1104, the security analyst may begin to edit the new task. For example, the analyst may begin to enter a name for the new task. This may be performed as illustrated in FIG. 6D. As the analyst types a name for the new task, the security operation platform may compare the characters input by the security analyst to a database of tasks and may make a prediction as to which task the analyst is attempting to input. The security operation platform may also determine one or more other tasks which are commonly associated with other tasks existing in the playbook.

At step 1105, the security analyst may be presented with the tasks suggested or recommended by the security operation platform based on the security analyst's input as well as any tasks suggested by the security operation platform based on popularity given the other tasks in the playbook. The suggested tasks may be presented as illustrated in FIG. 6D.

At step 1106, the security analyst may select one of the suggested or recommended tasks, select a different existing task, or create a new task.

At step 1107, based on the selection by the security analyst in step 1106, the security operation platform may update any databases used in its selection of recommended or suggested tasks to reflect the choice by the security analyst in step 1106. In this way, the security operation platform may adapt to actual choices made by security analysts to aid with any future recommendations.

At step 1108, after selecting a new task, the security analyst may be presented with one or more recommended inputs. The security analyst may also be presented with a listing of outputs of any higher-level tasks. For example, as illustrated in FIG. 5F, inputs for a particular task may be selected from any outputs of any preceding tasks. The security operation platform may also be capable of generating a list of recommended inputs for the new task based on factors such as popular past selections by the same or other analysts in a similar position. The listing of possible and suggested inputs may be presented in a window 591 as illustrated in FIG. 5F.

At step 1109, the security analyst may select one or more inputs for the new task. As discussed herein, the inputs should be selected from one or more outputs of any preceding task. The security analyst may make the inputs through a user interface as illustrated in FIG. 5F.

At step 1110, based on the selection by the security analyst in step 1109, the security operation platform may update any databases used in its selection of recommended or suggested task inputs to reflect the choice by the security analyst in step 1109. In this way, the security operation platform may adapt to actual choices made by security analysts to aid with any future recommendations.

At step 1111, the analyst may finalize the new task creation and save the new task to the playbook. As discussed above, the method 1100 may be capable of being performed in the event of a security analyst editing an existing task as opposed to simply creating a new task. At step 1112, the method may end.

Embodiments include a method, comprising receiving, by a processor, a cyber-security incident information packet associated with a cyber-security incident via a network connection; creating, by the processor, based on the cyber-security incident information packet, a new cyber-security incident entry in an incident database; comparing, by the processor, workload levels for a plurality of security analysts; determining, based on one or more characteristics of the new cyber-security incident entry, one or more preferred characteristics; identifying, based on the comparison and the determined one or more characteristics, an ideal security analyst of the plurality of security analysts; and assigning the ideal security analyst as an owner of the new cyber-security incident.

Aspects of the above method include the method further comprising, prior to creating the new cyber-security incident entry in the incident database, determining the cyber-security incident information packet does not match an existing incident.

Aspects of the above method include the method further comprising notifying the ideal security analyst of the assignment.

Aspects of the above method include wherein the one or more characteristics comprise a minimum aptitude.

Aspects of the above method include wherein the minimum aptitude is associated with a technical field.

Aspects of the above method include the method further comprising updating, based on the assignment, the workload level for the ideal security analyst.

Aspects of the above method include wherein identifying the ideal security analyst comprises reading data from a security analyst aptitude database.

Embodiments include a computer program product comprising a non-transitory computer readable storage medium comprising computer readable program code embodied in the medium, wherein the computer readable program code, when executed by a processor, causes the processor to perform operations comprising receiving, by the processor, a cyber-security incident information packet associated with a cyber-security incident via a network connection; creating, by the processor, based on the cyber-security incident information packet, a new cyber-security incident entry in an incident database; comparing, by the processor, workload levels for a plurality of security analysts; determining, based on one or more characteristics of the new cyber-security incident entry, one or more preferred characteristics; identifying, based on the comparison and the determined one or more characteristics, an ideal security analyst of the plurality of security analysts; and assigning the ideal security analyst as an owner of the new cyber-security incident.

Aspects of the computer program product include wherein the operations determining the cyber-security incident information packet does not match an existing incident.

Aspects of the computer program product include wherein the operations further comprise notifying the ideal security analyst of the assignment.

Aspects of the computer program product include wherein the one or more characteristics comprise a minimum aptitude.

Aspects of the computer program product include wherein the minimum aptitude is associated with a technical field.

Aspects of the computer program product include wherein the operations further comprise updating, based on the assignment, the workload level for the ideal security analyst.

Aspects of the computer program product include wherein identifying the ideal security analyst comprises reading data from a security analyst aptitude database.

Embodiments include a computing device comprising: a processor; and a memory coupled to the processor and storing computer readable program code that when executed by the processor to perform operations comprising: receiving, by the processor, a cyber-security incident information packet associated with a cyber-security incident via a network connection; creating, by the processor, based on the cyber-security incident information packet, a new cyber-security incident entry in an incident database; comparing, by the processor, workload levels for a plurality of security analysts; determining, based on one or more characteristics of the new cyber-security incident entry, one or more preferred characteristics; identifying, based on the comparison and the determined one or more characteristics, an ideal security analyst of the plurality of security analysts; and assigning the ideal security analyst as an owner of the new cyber-security incident.

Aspects of the above computing device include wherein the operations further comprise, prior to creating the new cyber-security incident entry in the incident database, determining the cyber-security incident information packet does not match an existing incident.

Aspects of the above computing device include wherein the operations further comprise notifying the ideal security analyst of the assignment.

Aspects of the above computing device include wherein the one or more characteristics comprise a minimum aptitude.

Aspects of the above computing device include wherein the minimum aptitude is associated with a technical field.

Aspects of the above computing device include wherein the operations further comprise updating, based on the assignment, the workload level for the ideal security analyst.

Embodiments include a method comprising: determining, by a processor of a first computing device, a task of a playbook has been initiated on a security analyst device; determining, by the processor, one or more desired security analyst characteristics associated with the task; comparing, by the processor, the determined characteristics with one or more attributes of an owner of an incident associated with the task; determining, by the processor, based on the comparison, an expert security analyst should be assigned to the task; comparing, by the processor, the determined characteristics with one or more attributes of one or more security analysts; and determining, based on the comparison, one or more security analyst qualifying to be the expert.

Aspects of the above method include the method further comprising, prior to determining the task of the playbook has been initiated on the security analyst device, determining, by the processor, one of a new playbook has been loaded and a task has been completed.

Aspects of the above method include wherein the one or more desired security analyst characteristics are associated with a category of the task.

Aspects of the above method include wherein comparing the determined characteristics with one or more attributes of the owner of the incident associated with the task comprises determining if each of the one or more attributes of the owner of the incident is less than a threshold amount.

Aspects of the above method include wherein the one or more attributes of the one or more security analysts are retrieved from a database by the processor.

Aspects of the above method include the method further comprising transmitting a list of the one or more security analysts qualifying to be the expert to be displayed on a display of a security analyst device associated with the owner of the incident.

Aspects of the above method include the method further comprising receiving, by the processor, a selection of one of the one or more security analysts qualifying to be the expert from the security analyst device.

Aspects of the above method include the method further comprising assigning the selected security analyst to the task.

Aspects of the above method include the method further comprising assigning one of the one or more security analysts qualifying to be the expert as the expert.

Embodiments include a computer program product comprising: a non-transitory computer readable storage medium comprising computer readable program code embodied in the medium, wherein the computer readable program code, when executed by a processor, causes the processor to perform operations comprising: determining, by the processor, a task of a playbook has been initiated on a security analyst device; determining, by the processor, one or more desired security analyst characteristics associated with the task; comparing, by the processor, the determined characteristics with one or more attributes of an owner of an incident associated with the task; determining, by the processor, based on the comparison, an expert security analyst should be assigned to the task; comparing, by the processor, the determined characteristics with one or more attributes of one or more security analysts; and determining, based on the comparison, one or more security analyst qualifying to be the expert.

Aspects of the above computer program product include wherein the operations further comprise, prior to determining the task of the playbook has been initiated on the security analyst device, determining, by the processor, one of a new playbook has been loaded and a task has been completed.

Aspects of the above computer program product include wherein the one or more desired security analyst characteristics are associated with a category of the task.

Aspects of the above computer program product include wherein comparing the determined characteristics with one or more attributes of the owner of the incident associated with the task comprises determining if each of the one or more attributes of the owner of the incident is less than a threshold amount.

Aspects of the above computer program product include wherein the one or more attributes of the one or more security analysts are retrieved from a database by the processor.

Aspects of the above computer program product include wherein the operations further comprise transmitting a list of the one or more security analysts qualifying to be the expert to be displayed on a display of a security analyst device associated with the owner of the incident.

Aspects of the above computer program product include wherein the operations further comprise receiving, by the processor, a selection of one of the one or more security analysts qualifying to be the expert from the security analyst device.

Aspects of the above computer program product include wherein the operations further comprise assigning the selected security analyst to the task.

Aspects of the above computer program product include wherein the operations further comprise assigning one of the one or more security analysts qualifying to be the expert as the expert.

Embodiments include a computing device comprising: a processor; and a memory coupled to the processor and storing computer readable program code that when executed by the processor to perform operations comprising: determining, by the processor, a task of a playbook has been initiated on a security analyst device; determining, by the processor, one or more desired security analyst characteristics associated with the task; comparing, by the processor, the determined characteristics with one or more attributes of an owner of an incident associated with the task; determining, by the processor, based on the comparison, an expert security analyst should be assigned to the task; comparing, by the processor, the determined characteristics with one or more attributes of one or more security analysts; and determining, based on the comparison, one or more security analyst qualifying to be the expert.

Aspects of the above computer program product include wherein the operations further comprise, prior to determining the task of the playbook has been initiated on the security analyst device, determining, by the processor, one of a new playbook has been loaded and a task has been completed.

Embodiments include a method comprising: receiving a request from a security analyst device for a new task associated with a cyber-security incident; determining one or more previously completed tasks for the incident; determining an incident category associated with the incident; determining one or more commonly performed security actions associated with the incident category; determining which of the commonly performed actions have not been performed on the incident; determining a likelihood of success for each of the commonly performed actions that have not been performed; and determining one or more actions of the commonly performed actions, based on the determined likelihood, to transmit as suggested actions to the security analyst device.

Aspects of the above method include wherein the incident category comprises one or more of suspicious email, suspicious URL, and suspicious file.

Aspects of the above method include wherein the commonly performed security actions comprise one or more of verifying a URL and requesting information from a user.

Aspects of the above method include wherein determining the likelihood of success for each of the commonly performed actions that have not been performed comprises reading, for each of the commonly performed actions that have not been performed, an entry of a database.

Aspects of the above method include wherein the database comprises information associated with actions performed by a plurality of security analysts.

Aspects of the above method include wherein the information associated with actions performed by the plurality of security analysts comprises a field listing a success percentage for each of the actions performed by the plurality of security analysts.

Aspects of the above method include the method further comprising transmitting the one or more actions as suggested actions to the security analyst device.

Embodiments include a computer program product comprising: a non-transitory computer readable storage medium comprising computer readable program code embodied in the medium, wherein the computer readable program code, when executed by a processor, causes the processor to perform operations comprising: receiving a request from a security analyst device for a new task associated with a cyber-security incident; determining one or more previously completed tasks for the incident; determining an incident category associated with the incident; determining one or more commonly performed security actions associated with the incident category; determining which of the commonly performed actions have not been performed on the incident; determining a likelihood of success for each of the commonly performed actions that have not been performed; and determining one or more actions of the commonly performed actions, based on the determined likelihood, to transmit as suggested actions to the security analyst device.

Aspects of the above computer program product include wherein the incident category comprises one or more of suspicious email, suspicious URL, and suspicious file.

Aspects of the above computer program product include wherein the commonly performed security actions comprise one or more of verifying a URL and requesting information from a user.

Aspects of the above computer program product include wherein determining the likelihood of success for each of the commonly performed actions that have not been performed comprises reading, for each of the commonly performed actions that have not been performed, an entry of a database.

Aspects of the above computer program product include wherein the database comprises information associated with actions performed by a plurality of security analysts.

Aspects of the above computer program product include wherein the information associated with actions performed by the plurality of security analysts comprises a field listing a success percentage for each of the actions performed by the plurality of security analysts.

Aspects of the above computer program product include wherein the operations further comprise transmitting the one or more actions as suggested actions to the security analyst device.

Embodiments include a computing device comprising: a processor; and a memory coupled to the processor and storing computer readable program code that when executed by the processor to perform operations comprising: receiving a request from a security analyst device for a new task associated with a cyber-security incident; determining one or more previously completed tasks for the incident; determining an incident category associated with the incident; determining one or more commonly performed security actions associated with the incident category; determining which of the commonly performed actions have not been performed on the incident; determining a likelihood of success for each of the commonly performed actions that have not been performed; and determining one or more actions of the commonly performed actions, based on the determined likelihood, to transmit as suggested actions to the security analyst device.

Aspects of the above computing device include wherein the incident category comprises one or more of suspicious email, suspicious URL, and suspicious file.

Aspects of the above computing device include wherein the commonly performed security actions comprise one or more of verifying a URL and requesting information from a user.

Aspects of the above computing device include wherein determining the likelihood of success for each of the commonly performed actions that have not been performed comprises reading, for each of the commonly performed actions that have not been performed, an entry of a database.

Aspects of the above computing device include wherein the database comprises information associated with actions performed by a plurality of security analysts.

Aspects of the above computing device include wherein the information associated with actions performed by the plurality of security analysts comprises a field listing a success percentage for each of the actions performed by the plurality of security analysts.

The illustrative systems and methods of this invention have been described in relation to a security operation platform. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the illustrative embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

For example in one alternative embodiment, the data stream reference module is applied with other types of data structures, such as object oriented and relational databases.

In another alternative embodiment, the data stream reference module is applied in architectures other than contact centers, such as workflow distribution systems.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Illustrative hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, by a processor, a cyber-security incident information packet associated with a cyber-security incident via a network connection;
creating, by the processor, based on the cyber-security incident information packet, a new cyber-security incident entry in an incident database;
comparing, by the processor, workload levels for a plurality of security analysts;
determining, based on one or more characteristics of the new cyber-security incident entry, one or more preferred characteristics;
identifying, based on the comparison and the determined one or more characteristics, an ideal security analyst of the plurality of security analysts; and
assigning the ideal security analyst as an owner of the new cyber-security incident.

2. The method of claim 1, further comprising, prior to creating the new cyber-security incident entry in the incident database, determining the cyber-security incident information packet does not match an existing incident.

3. The method of claim 1, further comprising notifying the ideal security analyst of the assignment.

4. The method of claim 1, wherein the one or more characteristics comprise a minimum aptitude.

5. The method of claim 4, wherein the minimum aptitude is associated with a technical field.

6. The method of claim 1, further comprising updating, based on the assignment, the workload level for the ideal security analyst.

7. The method of claim 1, wherein identifying the ideal security analyst comprises reading data from a security analyst aptitude database.

8. A computer program product comprising:
a non-transitory computer readable storage medium comprising computer readable program code embodied in the medium, wherein the computer readable program code, when executed by a processor, causes the processor to perform operations comprising:
receiving, by the processor, a cyber-security incident information packet associated with a cyber-security incident via a network connection;
creating, by the processor, based on the cyber-security incident information packet, a new cyber-security incident entry in an incident database;
comparing, by the processor, workload levels for a plurality of security analysts;
determining, based on one or more characteristics of the new cyber-security incident entry, one or more preferred characteristics;
identifying, based on the comparison and the determined one or more characteristics, an ideal security analyst of the plurality of security analysts; and
assigning the ideal security analyst as an owner of the new cyber-security incident.

9. The computer program product of claim 8, wherein the operations further comprise, prior to creating the new cyber-security incident entry in the incident database, determining the cyber-security incident information packet does not match an existing incident.

10. The computer program product of claim 8, wherein the operations further comprise notifying the ideal security analyst of the assignment.

11. The computer program product of claim 8, wherein the one or more characteristics comprise a minimum aptitude.

12. The computer program product of claim 11, wherein the minimum aptitude is associated with a technical field.

13. The computer program product of claim 8, wherein the operations further comprise updating, based on the assignment, the workload level for the ideal security analyst.

14. The computer program product of claim 8, wherein identifying the ideal security analyst comprises reading data from a security analyst aptitude database.

15. A computing device comprising:
a processor; and
a memory coupled to the processor and storing computer readable program code that when executed by the processor to perform operations comprising:
receiving, by the processor, a cyber-security incident information packet associated with a cyber-security incident via a network connection;
creating, by the processor, based on the cyber-security incident information packet, a new cyber-security incident entry in an incident database;
comparing, by the processor, workload levels for a plurality of security analysts;
determining, based on one or more characteristics of the new cyber-security incident entry, one or more preferred characteristics;
identifying, based on the comparison and the determined one or more characteristics, an ideal security analyst of the plurality of security analysts; and
assigning the ideal security analyst as an owner of the new cyber-security incident.

16. The computing device of claim 15, wherein the operations further comprise, prior to creating the new cyber-security incident entry in the incident database, determining the cyber-security incident information packet does not match an existing incident.

17. The computing device of claim 15, wherein the operations further comprise notifying the ideal security analyst of the assignment.

18. The computing device of claim 15, wherein the one or more characteristics comprise a minimum aptitude.

19. The computing device of claim 18, wherein the minimum aptitude is associated with a technical field.

20. The computing device of claim 15, wherein the operations further comprise updating, based on the assignment, the workload level for the ideal security analyst.
